(19) United States
(12) Patent Application Publication
(10) Pub. No.: US 2004/0057622 A1
(43) Pub. Date: Mar. 25, 2004

(54) Method, apparatus and system for using 360-degree view cameras to identify facial features

(76) Inventor: Gary R. Bradski, Palo Alto, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/254,304

(22) Filed: Sep. 25, 2002

(51) Int. Cl. G06K 9/64; G06K 9/46; G06K 9/36; G06K 9/66

(52) U.S. Cl. 382/217; 382/190; 382/276

(57) ABSTRACT

A method, apparatus and system identify the location of eyes. Specifically, a 360-degree camera is used to generate images of a face and identify the location of eyes in the face. A first light source on the axis of the 360-degree camera projects light towards the face and a first polar coordinate image is generated from the light that is returned from the face. A second light source off the axis of the 360-degree camera projects light towards the face and a second polar coordinate image is generated from the light that is returned from the face. The first and the second images are then compared to each other and a contrast area is identified to indicate the location of the eyes. The first and second polar coordinate images may be automatically converted into perspective images for various applications such as teleconferencing.

### FIELD OF THE INVENTION

The present invention relates to the field of computer vision. More specifically the present invention relates to a method, apparatus and system for using a 360-degree view camera to identify the location of eyes on a face and to automatically generate perspective views of the face regions found in 360-degree images.

### BACKGROUND OF THE INVENTION

Computer vision is being used today in an increasing number of applications. The technology is primarily used in areas such as robotics, teleconferencing, surveillance, security, and other similar applications. These applications generally rely on imaging devices to receive as much information as possible about the environment surrounding the devices. Unfortunately, traditional imaging devices such as cameras and video lenses tend to restrict the viewing field of the imaging devices to a relatively small angle (as measured from the center of projection of the imaging device lens), thus limiting the functionality of these applications.

New imaging devices have emerged to provide improved imaging input to computer vision applications. A variety of devices known as “360-degree cameras” have been developed over time, all attempting to enable omni-directional viewing and imaging. More specifically, 360-degree cameras enable an image sensor to capture images in all directions surrounding a center of projection to produce a full field of view for images. 360-degree view cameras may be built using multiple camera views, viewing a convex mirror surface, and/or using a fisheye lens. A more sophisticated alternative is the OMNICAM™, developed by a team of researchers at Columbia University. The OMNICAM™ may capture an image of a 360-degree half-sphere polar coordinate image around the camera without moving.

### BRIEF DESCRIPTION OF THE DRAWINGS

The present invention is illustrated by way of example and not limitation in the figures of the accompanying drawings in which like references indicate similar elements, and in which:

FIG. 1 illustrates how a prior art omni-camera projects an image onto an imaging plane.

FIG. 2 illustrates a prior art embodiment of an omni-camera.

FIG. 3 illustrates two omni-cameras functioning as a single omni-camera to capture a 360-degree complete spherical view.

FIG. 4 illustrates light being projected towards a face from a light source on the omni-camera axis.

FIG. 5 illustrates light being projected towards a face from a light source off the omni-camera axis.

FIG. 6 illustrates the resulting image when an on-axis image is subtracted from an off-axis image.

FIG. 7 illustrates one embodiment of the present invention.

FIG. 8 illustrates the resulting images (in both polar and Cartesian coordinates) generated by one embodiment of the present invention.

FIG. 9 is a flow chart illustrating an application using an embodiment of the present invention.

FIG. 10 illustrates a stereo embodiment of the present invention.

### DETAILED DESCRIPTION

The present invention discloses a method, apparatus and system for using 360-degree view cameras (hereafter “omni-cameras”) to identify facial characteristics. More specifically, embodiments of the present invention may use omni-cameras to identify the location of eyes in a face, and based on the location of the eyes, identify remaining facial features. Embodiments of the present invention may have significant applications in teleconferencing, for example, where a single omni-camera may be placed in the center of a room to capture images of the entire room. Alternate embodiments may include robotics applications such as automated navigation systems. Other embodiments may also be invaluable to security applications where a single omni-camera may be used to capture activities in an entire sphere without having to rotate the camera and/or without using multiple cameras.

Reference in the specification to “one embodiment” or “an embodiment” of the present invention means that a particular feature, structure or characteristic described in connection with the embodiment is included in at least one embodiment of the present invention. Thus, the appearances of the phrases “in one embodiment,” “according to one embodiment” or the like appearing in various places throughout the specification are not necessarily all referring to the same embodiment.

The following description assumes the use of an omni-camera, such as the “OMNICAM™, to illustrate embodiments of the present invention. It will be readily apparent to those of ordinary skill in the art, however, that embodiments of the present invention may also be practiced with multiple camera views, by viewing a convex mirror surface, by using a fisheye lens, and/or by any other devices capable of capturing omni-directional images.

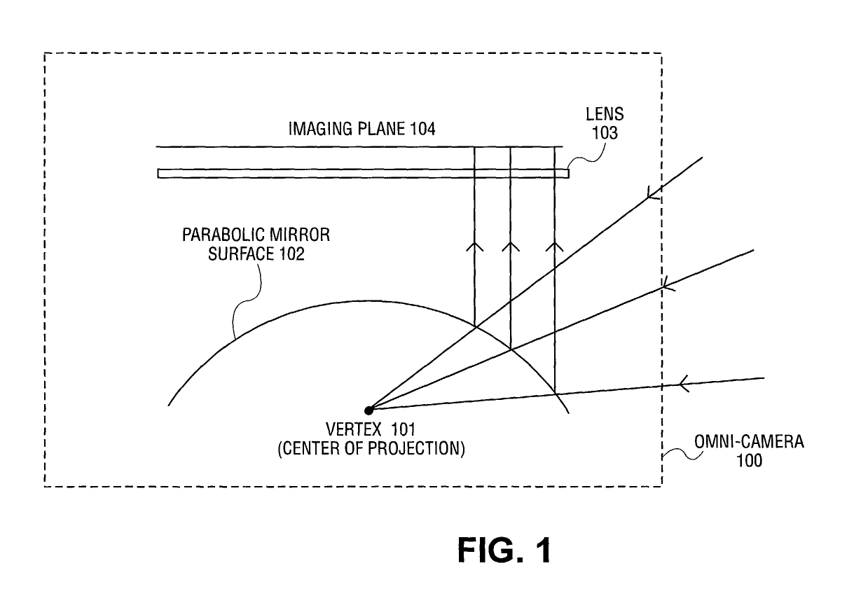

The following is a general description of how an omni-camera such as the OMNICAM™ functions. According to one embodiment, the omni-camera comprises an orthographic camera, a lens and a parabolic mirror. An orthographic camera is one in which parallel light rays remain parallel rather than converging, as is the case with a traditional perspective camera. Thus, for example, in a traditional perspective camera, closer objects appear larger, but in an orthographic camera, the objects appear true to size. This embodiment is illustrated in FIG. 1 where Omni-camera 100 includes Vertex 101, namely the center of projection, Parabolic Mirror Surface 102 that reflects light rays projected towards Omni-camera 100. Orthographic Lens 103 directs light onto Imaging Plane 104, which may be a charge-coupled device (“CCD”) or complementary metal-oxide semiconductor (“CMOS”) sensitive surface on digital cameras, or a frame of film in non-digital cameras. According to an alternate embodiment, an omni-camera may use a relay lens in front of a standard perspective camera to generate an orthographic projection onto an imaging surface. The manner in which relay lenses collimate light rays is well known to those of ordinary skill in the art and further description of such is omitted herein in order not to obscure the present invention.

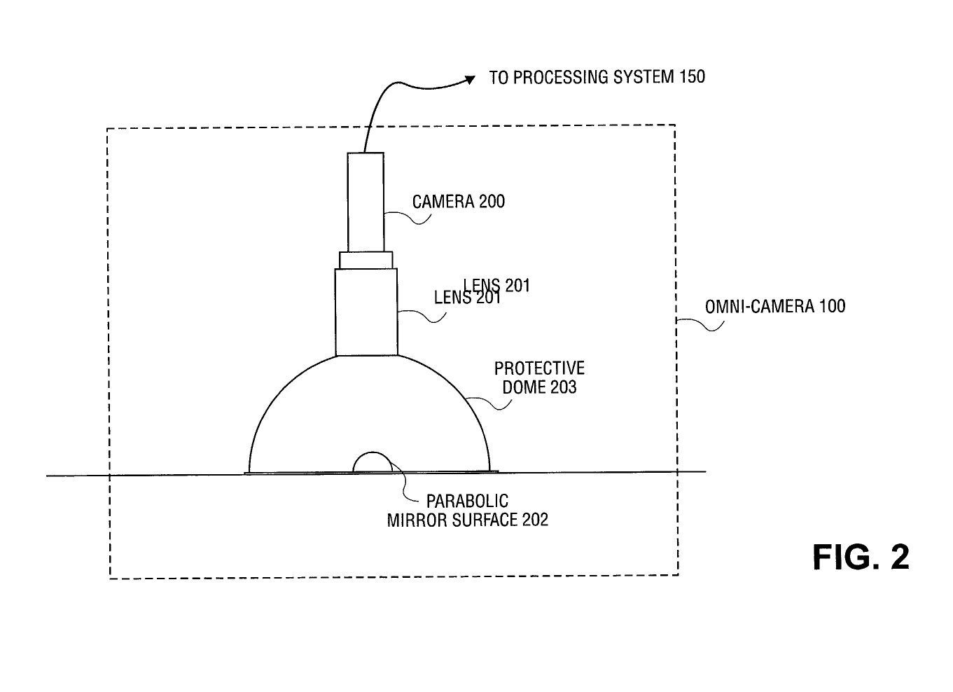

FIG. 2 illustrates one embodiment of Omni-camera 100 in further detail. According to one embodiment, Omni-camera 100 comprises a Camera 200, Lens 201, Parabolic Mirror Surface 202 and Protective Dome 203. Protective Dome 203 functions as a protective covering to protect the sensitive equipment within the dome from dust particles. Camera 200 may be any type of camera capable of capturing an image, including but not limited to, an orthographic camera and/or a traditional perspective camera. According to one embodiment, Camera 200 may be a depth camera, capable of capturing three-dimensional images. Lens 201 may be any lens, including but not limited to a telecentric lens and/or a relay lens, whichever is appropriate for the type of camera selected. The type of lens appropriate for the camera selected will be apparent to one of ordinary skill in the art. According to one embodiment, Omni-camera 100 may also include, and/or be coupled to, Processing System 150 capable of processing the half-sphere 360-degree images captured by Omni-camera 100.

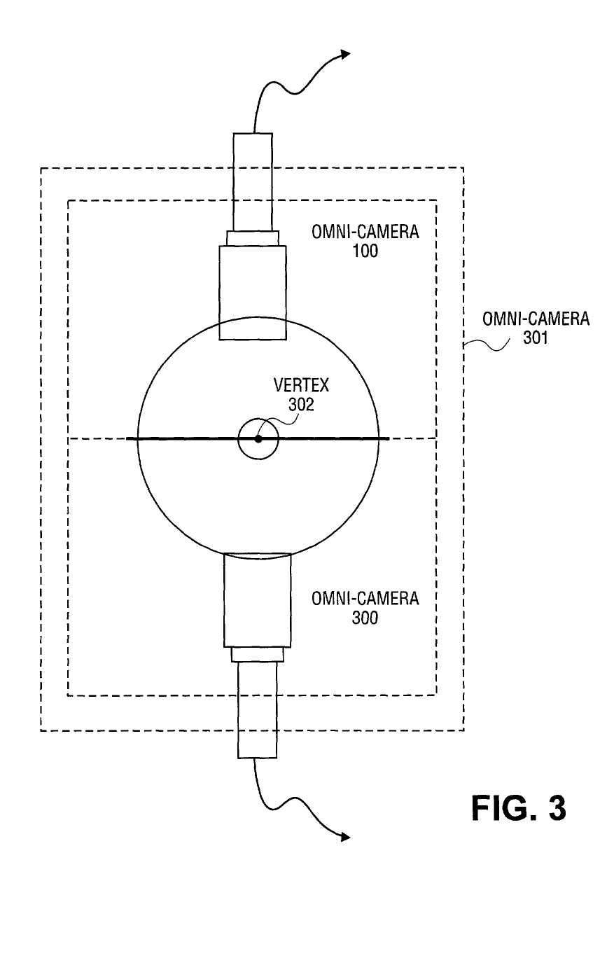

According to one embodiment, two omni-cameras may be placed back-to-back such that the foci of the parabolic mirrors for each unit coincide, thus effectively behaving like a single omni-directional camera that has a single center of projection and a full-sphere 360-degree field of view. FIG. 3 illustrates two omni-cameras placed back-to-back in such a fashion. As illustrated, Omni-camera 100 and Omni-camera 300 may, in combination, function like a single omni-directional camera (“Omni-camera 301”) with Vertex 302. Vertex 302 represents the center of projection for Omni-camera 301. Omni-camera 301 may capture the full-sphere 360-degree field of view and generate a 360-degree image in polar coordinate (hereafter “polar coordinate image”).

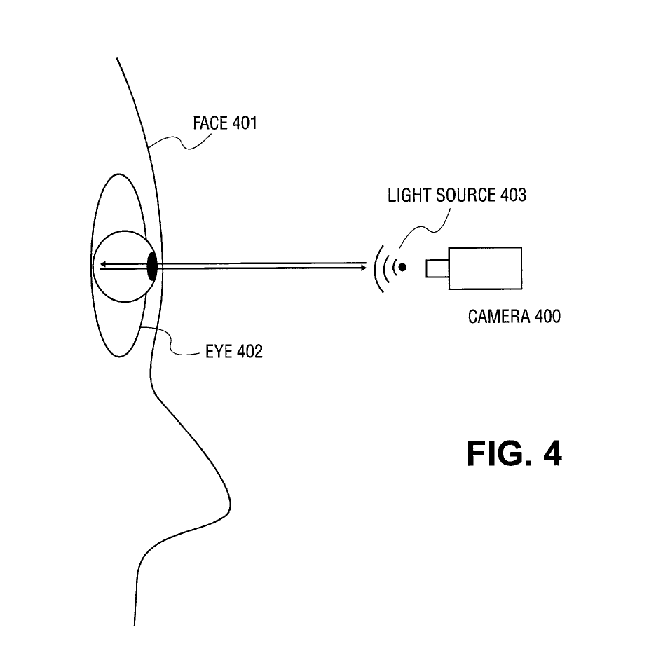

According to one embodiment, an omni-camera may be utilized to identify the location of eyes, or more specifically pupils of eyes, in a face. The terms “eyes” and “pupils” are used interchangeably in this specification. Retinas in eyes behave like “directional reflectors” and reflect light back in the direction from which the light is transmitted. FIGS. 4-6 illustrate this behavior. As shown in FIG. 4, when Camera 400 is used to take a picture of Face 401 (including Eye 402), the light projected by Light Source 403 (the camera's flash) may be reflected back to Light Source 403. In the event the flash is on Camera 400's optical axis, as in FIG. 4, most of the light will be reflected off the retina at the back of Eye 402 and be returned to Light Source 403. This scenario traditionally leads to the “red eye” phenomenon where the eyes in the resulting photograph look red due to the returned light being colored red by the capillaries inside Eye 402.

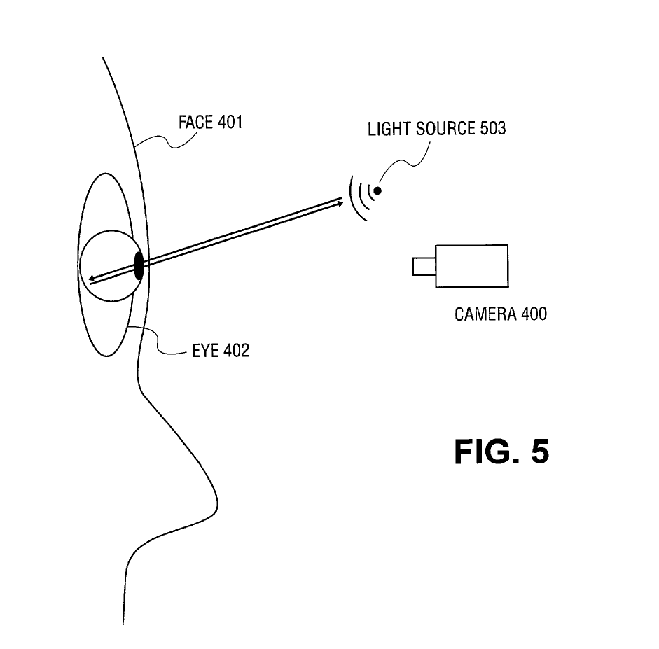

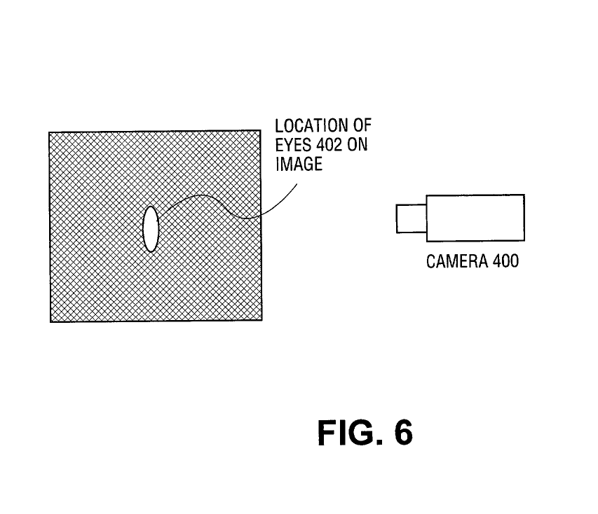

If, however, the light source is moved off Camera 400's optical axis (“Light Source 503”), as illustrated in FIG. 5, the reflected light may not be returned in the direction of Camera 400 but instead away from Camera 400 towards Light Source 503. To Camera 400, the lack of returned light results in the pupils appearing as dark areas on an image (or light areas in a negative image). Given that human flesh approximates a “Lambertian surface,” namely a surface that diffuses light in all directions, the surrounding flesh regions of Face 401 return approximately the same amount of light to the camera in both configurations. If the resulting image from the former configuration is “subtracted” from the resulting image from the latter configuration, the exact location of the Eyes 402 may be determined, as illustrated in FIG. 6. The process of subtraction is well known in the art and may include a pixel by pixel comparison of corresponding pixels in each image.

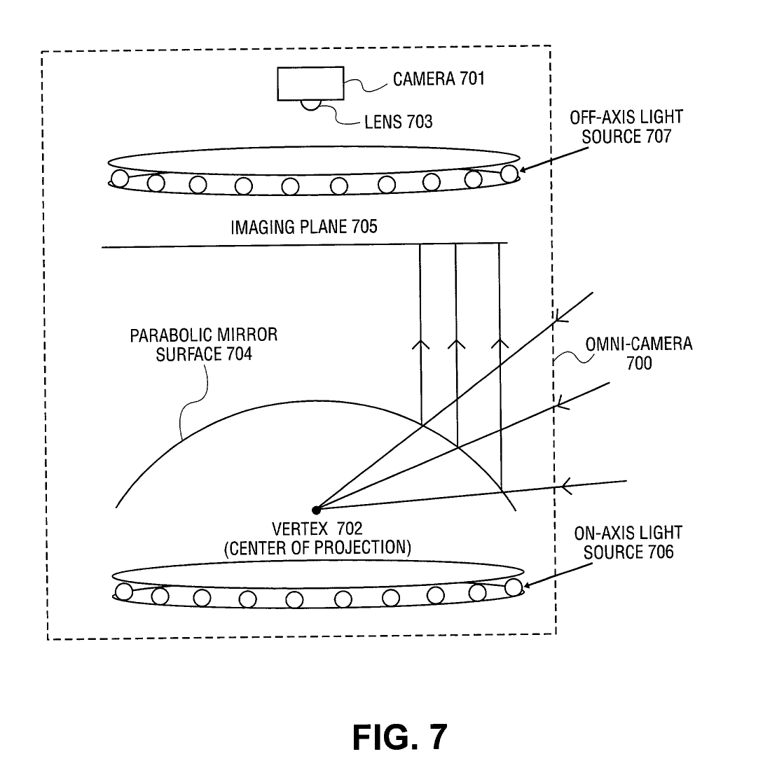

According to one embodiment of the present invention, a single omni-camera may be used to identify the location of eyes on a face in a half-sphere 360-degree image. In an alternate embodiment, two back-to-back omm-cameras may be used to do the same in a full-sphere 360-degree image. The former embodiment is illustrated in FIG. 7. Specifically, as illustrated in FIG. 7, the lighting sources of Omni-camera 700 may be configured to enable Omni-camera 700 to capture images with light sources in varying positions. According to one embodiment, Omni-camera 700 may include Vertex 702 (representing the center of projection), Parabolic Mirror Surface 704, Imaging Plane 705 and a relay lens in front of Imaging Plane 705. The relay lens is omitted in FIG. 7 for clarity. Additionally, Omni-camera 700 may also include, and/or be couple to, Light Source 706, providing light on the camera axis, and Light Source 707, providing light off the camera axis. In an alternate embodiment, Light Source 706 may be placed in a ring around the relay lens of Omni-camera 700 to provide on-axis illumination.

In order to identify the location of eyes on a face, Omni-camera 700 may capture a first image of a face with light from Light Source 704 (“on-axis image”) and a second image of the face with light from Light Source 705 (“off-axis image”). The order in which the images are captured is not critical to the spirit of the invention, i.e. the off-axis image may just as easily be capture prior to the on-axis image. According to one embodiment, the off-axis image may then be compared to the on-axis image, and the resulting differences in the images may indicate the location of eyes. More specifically, according to an embodiment, the off-axis image may be subtracted from the on-axis image and the resulting contrast areas in the images may indicate the location of eyes. In one embodiment, the subtraction is accomplished by comparing each pixel in the on-axis image to the corresponding pixel in the off-axis image. The resulting contrast area indicating the location of eyes may then be identified in the “subtracted image.” The location of the eye regions (the subtracted image) may be used by various applications to identify other facial features, such as the nose and mouth.

According to one embodiment, eye locations may be identified simply by examining the dark regions on the off-axis image(s). This embodiment, however, may yield significant errors because the dark regions in the images may not always represent eye locations. Instead, some of the dark regions may represent holes and/or dark colors in the image. According to an embodiment of the present invention wherein the off-axis image is compared to the on-axis image, however, the dark regions corresponding to holes and/or dark colors may be eliminated as eye locations because these anomalies may appear on both the on-axis and off-axis images, and therefore subtraction of one from the other will not yield a contrast area.

According to one embodiment, Omni-camera 700 generates a 360-degree polar coordinate image, and any portion of this image may be transformed into a perspective image. In other words, it will be readily apparent to one of ordinary skill in the art that the polar coordinates in the spherical view projected by Omni-camera 700 may be easily transformed into a perspective image having Cartesian coordinates (hereafter “Cartesian coordinate image”). According to one embodiment, this transformation from polar to Cartesian coordinates may be accomplished as follows:

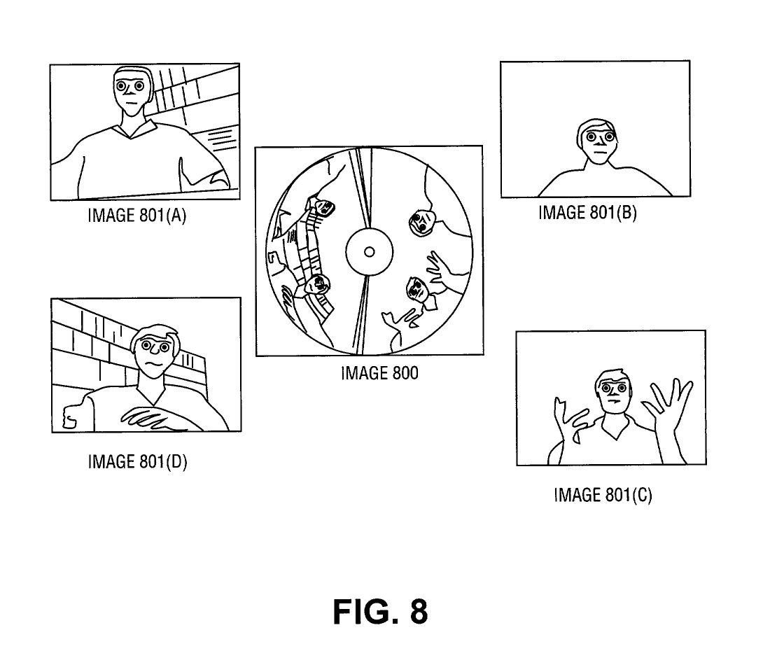

FIG. 8 illustrates polar coordinate image, Image 800, generated according to one embodiment of the present invention utilizing two back-to-back omni-cameras. Specifically, on-axis and off-axis images of a room may be generated, and these images may be compared to identify the locations of eyes in the room. As illustrated in FIG. 8, four sets of eyes may be identified in the room, and upon confirmation of these eye locations, facial features surrounding these eye regions may be identified. According to one embodiment, pattern recognition techniques may be applied to the on-axis and/or off-axis images to confirm whether candidate face regions exist in the room. Pattern recognition techniques are known in the art and further details are omitted herein in order not to obscure the present invention.

In the event pattern recognition techniques are applied, the on-axis and off-axis images may be compared only if candidate face regions are identified. According to an alternate embodiment, however, no pattern recognition techniques are used and the on-axis and off-axis images are always compared to each other. FIG. 8 also illustrates Image 800 transformed from the 360-degree full-sphere polar coordinate image to perspective views (Cartesian coordinate Images 801(a)-(d)), using a polar to Cartesian coordinate transformation technique. As illustrated, according to one embodiment, a teleconferencing application may accept images captured by an omni-camera, and automatically generate perspective views from one or more polar coordinate image(s) of a conference room and the conference participants.

To avoid false positive identification of eye locations, one embodiment of the present invention may also apply verification techniques such as “difference of Gaussians” eye pupil detectors to verify or reject particular regions as a candidate eye region. These verification techniques generally take advantage of the well-known fact that eye regions have bright areas surrounding a dark iris and pupils. Thus, for example, if a small, shiny curved surface is present in an image, although one embodiment of the present invention may identify that location as a potential eye location, the verification techniques will eliminate that location as a potential eye location because the small, shiny curved surface does not match the expected light-dark-light pattern of an eye. These verification techniques are well known in the art and descriptions of such are omitted herein in order not to obscure the present invention.

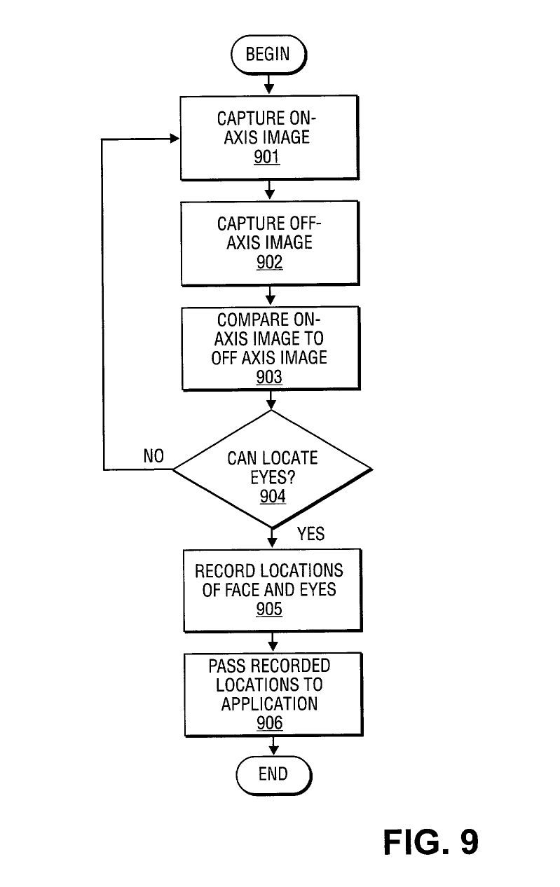

According to one embodiment of the present invention, once the locations of eye pupils are identified, the information may be provided to a variety of applications. As described above, applications that may benefit from being able to identify the location of the eye pupils include, but are not limited to, robotics, teleconferencing, surveillance, security, and other similar applications that capture and use facial images. FIG. 9 is a flow chart of an application using an embodiment of the present invention. In block 901, the omni-camera captures an on-axis image, and in block 902, the omni-camera captures an off-axis image. In an alternative embodiment, the omni-camera may first capture the off-axis image followed by the on-axis image. The order in which these images are captured do not affect the spirit of the present invention.

The on-axis and off-axis images may be compared in block 903. If eye regions are detected in block 904, the locations of the eye regions may be recorded in block 905 and the information may then be passed on to an application in block 906. The application may, for example, comprise a teleconferencing application where the eye locations may be used to identify other facial features, such as a mouth, and the location of the mouth may be used to better target the application's microphone arrays towards the teleconference participant's mouth.

According to one embodiment, depth measurements associated with the on-axis and off-axis images may enable applications to better generate facial images. Thus, for example, upon identification of eye locations in an image, depth measurements may also be calculated. It is well known in the art that light decreases according to the square of the distance value from the light source. The brightness of flesh regions surrounding the eyes may therefore be used to approximate the distance of the eye from the light source. This distance approximation may be used to identify eye locations in three dimensions (“3-D”).

According to an embodiment, the omni-camera may first be calibrated with the brightness of surrounding flesh regions recorded from two different locations, namely the nearest expected distance “Zmin” and the farthest useful distance “Zmax” (corresponding to the maximum brightness “Bmax” and the minimum brightness “Bmin” of the light source). Then, a measured brightness “B” may be converted to “Bfrac”, the fraction of the distance B lies between Bmax and Bmin, as follows:

$$Bfrac = 1.0 - \frac{B - Bmin}{Bmax - Bmin}$$

Since brightness falls off with the square of distance “Z”, the fraction of distance between Zmax and Zmin may be determined as follows:

Zfrac=\sqrt{Bfrac}

Finally, the distance “Z” from the camera may be calculated as the fraction of the distance between Zmax and Zmin offset by the minimal distance Zmin, as follows:

Z=Zfrac⇄(Z max−Z min)+Z min

As illustrated above, the value of brightness B may be used by applications such as teleconferencing applications, to determine Z, namely the distance between a teleconference camera and a light source (“depth value”). This depth value may, in turn, be used by the teleconferencing application to more accurately target microphone arrays towards a person's mouth in 3-D.

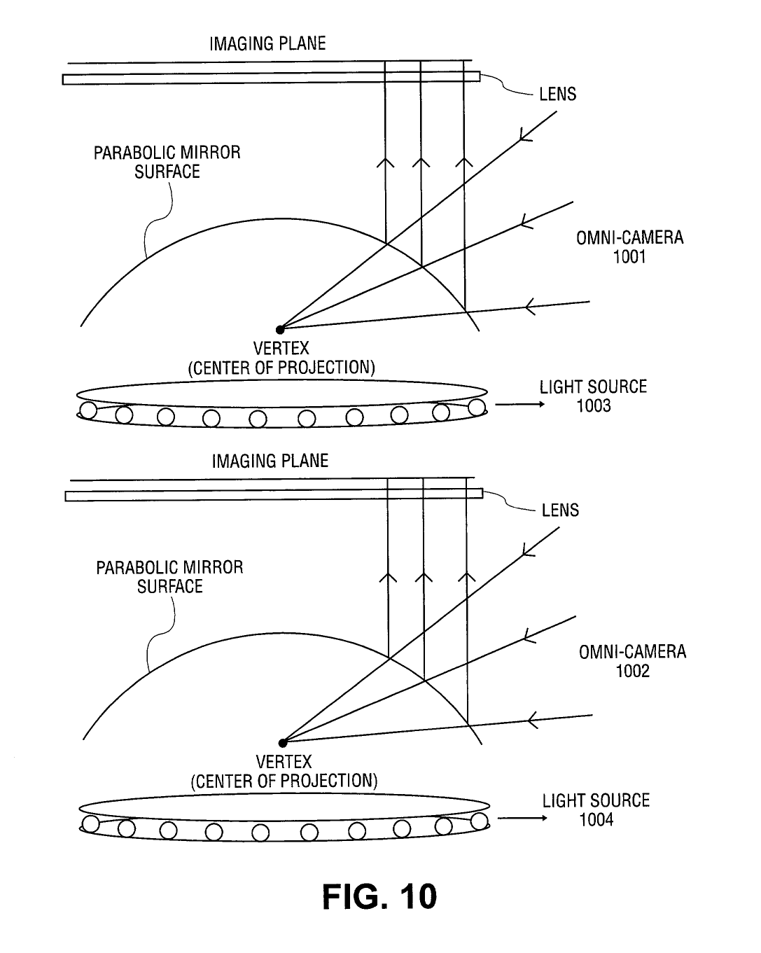

According to an embodiment of the present invention, to enable more precise depth measurements, omni-cameras may be configured to capture images in stereo. These stereo images may be used to determine not only the location of eyes on a face, but also the distance of eye pupils from the omni-cameras. More specifically, as illustrated in FIG. 10, two omni-cameras may be configured such that Light Source 1003 from Omni-camera 1001 is on-axis for Omni-camera 1001 and off-axis for Omni-camera 1002, and Light Source 1004 from Omni-camera 1002 is on-axis for Omni-camera 1002 and off-axis for Omni-camera 1001. The resulting on-axis and off-axis images for each omni-camera may then be used to determine the location of the eyes in the image as well as the distance from the camera to the eye pupils. According to one embodiment, the distance may be calculated by stereo correspondence triangulation. Triangulation techniques are well known in the art and further description of such is omitted herein in order not to obscure the present invention.

According to one embodiment, an omni-camera may be coupled to a processing system capable of executing instructions to accomplish an embodiment of the present invention. The processing system may include and/or be coupled to at least one machine-accessible medium. As used in this specification, a “machine” includes, but is not limited to, a computer, a network device, a personal digital assistant, and/or any device with one or more processors. A “machine-accessible medium” includes any mechanism that stores and/or transmits information in any form accessible by a machine, the machine-accessible medium including but not limited to, recordable/non-recordable media (such as read only memory (ROM), random access memory (RAM), magnetic disk storage media, optical storage media and flash memory devices), as well as electrical, optical, acoustical or other form of propagated signals (such as carrier waves, infrared signals and digital signals).

According to an embodiment, the processing system may further include various well-known components such as one or more processors. The processor(s) and machine accessible media may be communicatively coupled using a bridge/memory controller, and the processor may be capable of executing instructions stored in the machine accessible media. The bridge/memory controller may be coupled to a graphics controller, and the graphics controller may control the output of display data on a display device. The bridge/memory controller may be coupled to one or more buses. A host bus host controller such as a Universal Serial Bus (“USB”) host controller may be coupled to the bus(es) and a plurality of devices may be coupled to the USB. For example, user input devices such as a keyboard and mouse may be included in the processing system for providing input data.

In the foregoing specification, the invention has been described with reference to specific exemplary embodiments thereof. It will, however, be appreciated that various modifications and changes may be made thereto without departing from the broader spirit and scope of the invention as set forth in the appended claims. The specification and drawings are, accordingly, to be regarded in an illustrative rather than a restrictive sense.

What is claimed is:

1. A method of identifying a location of an eye on a face, comprising:
generating an on-axis image of the face using a first light projected towards the face from a first lighting source on an axis of a 360-degree imaging device;
generating an off-axis image of the face using a second light projected towards the face by a second lighting source off the axis of the 360-degree imaging device; and
comparing the on-axis image to the off-axis image to identify a contrast area indicating the location of the eye.

2. The method according to claim 1 wherein generating the on-axis image of the face further comprises generating the on-axis image of the face using light reflected back from the first light projected towards the face.

3. The method according to claim 1 wherein generating the off-axis image of the face further comprises generating the off-axis image of the face using light reflected back from the second light projected towards the face.

4. The method according to claim 1 wherein comparing the on-axis image with the off-axis image further comprises subtracting the on-axis image from the off-axis image to identify the contrast area indicating the location of the eye.

5. The method according to claim 1 further comprising generating a facial image based on the location of the eye.

6. The method according to claim 5 wherein the on-axis image and the of-axis image comprise polar coordinate images.

7. The method according to claim 6 further comprising translating at least one of the polar coordinate images to a Cartesian coordinate image.

8. A method of identifying a location of an eye on a face, comprising:
projecting a first light towards the face from a first lighting source on an axis of a 360-degree imaging device;
receiving a first returned light from the face;
generating an on-axis image of the face using the first returned light;
projecting a second light towards the face from a second lighting source off the axis of the 360-degree imaging device;
receiving a second returned light from the face;
generating an off-axis image of the face using the second returned light;
comparing the on-axis image to the off-axis image to identify a contrast area indicating the location of the eye.

9. The method according to claim 8 wherein comparing the on-axis image with the off-axis image further comprises subtracting the on-axis image of the face from the off-axis image of the face to identify the contrast area indicating the location of the eye.

10. The method according to claim 8 further comprising generating a facial image based on the location of the eye.

11. The method according to claim 8 wherein the on-axis image and the off-axis image are polar coordinate images.

12. The method according to claim 11 further comprising translating at least one of the polar coordinate images to a Cartesian coordinate image.

13. A method for generating a facial image, comprising:
receiving an on-axis image generated from a first light projected from a first light source on an axis of a 360-degree imaging device;
receiving an off-axis image generated from a second light projected from a second light source off the axis of the 360-degree imaging device; and
comparing the on-axis image to the off-axis image to identify a contrast area indicating the location of the eye.

14. The method according to claim 13 wherein comparing the on-axis image to the off-axis image further comprises subtracting the on-axis image from the off-axis image to identify the contrast area indicating the location of the eye.

15. The method according to claim 13 further comprising generating a facial image based on the location of the eye.

16. The method according to claim 13 wherein the on-axis image and the off-axis image comprise polar coordinate images.

17. The method according to claim 16 further comprising translating at least one of the polar coordinate images to a Cartesian coordinate image.

18. A system for identifying a location of an eye on a face, comprising:
a 360-degree imaging device;
a first light source located on an axis of the 360-degree imaging device;
a second light source located off an axis of the 360-degree imaging device;
an image generator capable of generating an on-axis image of the face using the first light returned from the face, the first light being projected towards the face from the first light source, the image generator further capable of generating an off-axis image of the face using the second light returned from the face, the second light being projected towards the face from the second light source; and
a processor capable of comparing the on-axis image to the off-axis image to identify a contrast area indicating the location of the eye.

19. The system according to claim 18 wherein the processor is further capable of comparing the on-axis image to the off-axis image by subtracting the on-axis image from the off-axis image to identify the contrast area indicating the location of the eye.

20. The system according to claim 18 wherein the image generator is further capable of generating a facial image based on the location of the eye.

21. The system according to claim 18 wherein the on-axis image and the off-axis image are polar coordinate images, and the processor is further capable of translating at least one of the polar coordinate images to a Cartesian coordinate image.

22. An article comprising a machine-accessible medium having stored thereon instructions that, when executed by a machine, cause the machine to:
project light from a first light source towards a face, the first light source located on an optical axis of a 360-degree imaging device;
receive the first light returned from the face to the 360-degree imaging device;
generate an on-axis image from the first light returned from the face;
project light from a second light source towards a face, the second light source located off the optical axis of the 360-degree imaging device;
receive the second light returned from the face to the 360-degree imaging device;
generate an off-axis image from the second light returned from the face; and
compare the on-axis image to the off-axis image to identify a contrast area indicating the location of the eye.

23. The article according to claim 22 wherein the instructions, when executed by the machine, further cause the machine to subtract the on-axis image from the off-axis image to identify the contrast area indicating the location of the eye.

24. The article according to claim 22 wherein the instructions, when executed by the machine, further cause the machine to generate a facial image based on the location of the eye.

25. The article according to claim 22 wherein the on-axis image and the off-axis image comprise polar coordinate images, and the instructions, when executed by the machine, further cause the machine to translate at least one of the polar coordinate images to a Cartesian coordinate image.

26. An article comprising a machine-accessible medium having stored thereon instructions that, when executed by a machine, cause the machine to:
generate an on-axis image of a face using a first light projected towards the face from a first lighting source on an axis of a 360-degree imaging device;
generate an off-axis image of the face using a second light projected towards the face by a second lighting source off the axis of the 360-degree imaging device; and
compare the on-axis image to the off-axis image to identify a contrast area indicating the location of the eye.

27. The article according to claim 26 wherein the instructions, when executed by the machine, further cause the machine to:
generate the on-axis image of the face using light reflected back from the first light projected towards the face; and
generate the off-axis image of the face using light reflected back from the second light projected towards the face.

28. The article according to claim 26 wherein wherein the instructions, when executed by the machine, further cause the machine to compare the on-axis image with the off-axis image further comprises subtracting the on-axis image from the off-axis image to identify the contrast area indicating the location of the eye.

29. The article according to claim 26 wherein the instructions, when executed by the machine, further cause the machine to generate a facial image based on the location of the eye.

30. The article according to claim 26 wherein the on-axis image and the off-axis image are polar coordinate images and the instructions, when executed by the machine, further cause the machine to translate at least one of the polar coordinate images to a Cartesian coordinate image.
